(19) United States
(12) Patent Application Publication
(10) Pub. No.: US 2002/0187880 A1
(43) Pub. Date: Dec. 12, 2002

(54) Recreational device

(76) Inventor: Robert N. Johnson, Townsend, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/161,467

(22) Filed: May 31, 2002

Related U.S. Application Data
(60) Provisional application No. 60/296,578, filed on Jun. 7, 2001.

(51) Int. Cl. A63B 26/00; A61H 3/00; A47D 13/04; A63B 22/00

(52) U.S. Cl. 482/78; 482/66

(57) ABSTRACT

A recreational device having a large rotatable outer wheel, a frame disposed internally within the wheel and about which the wheel is rotatable, a pivotable foot platform attached to the frame, and a tail wheel assembly disposed aft of the large wheel and coupled to the platform. In use a rider stands on the platform, preferably in a sideways stance, and grasps hand grips on the frame members and steers the wheel by applying torque to the frame. The tail wheel assembly is coupled to the foot platform by pulleys and cable such that pivoting of the platform causes pivoting of the tail wheel assembly to aid in steering the device. A hand brake can be provided to control the speed of rotation of the wheel about the frame. A nose wheel assembly can be provided having a nose wheel forward of the large wheel and which can engage the ground during braking to aid in stable operation. The tail assembly can be folded for ease of storage and transport.

### CROSS REFERENCE TO RELATED APPLICATIONS

This application claims priority under 35 U.S.C. §119(e) to Provisional Patent Application serial No. 60/296,578 filed on Jun. 7, 2001; the disclosure of which is hereby incorporated by reference.

### STATEMENT REGARDING FEDERALLY SPONSORED RESEARCH OR DEVELOPMENT N/A

### BACKGROUND OF THE INVENTION

A recreational device is the subject of U.S. Pat. No. 4,302,006 of the same inventor as herein and the disclosure of which is incorporated herein by reference. The device comprises a rotatable outer ring or wheel, a pivotably mounted platform adapted to provide foot support for an individual, a stabilizer aft of the wheel and a grasping mechanism adapted to be held by the individual to enable the individual to apply torque to the wheel. The device is employed on a ski slope or other hill to approximate the feel and thrill of wintertime skiing. Use of the device of the aforesaid patent and tests and experiments have revealed the need for improvements to enhance the ease of use and safety thereof, and the need for improvements in the design and construction of the device for smoother riding over various terrains and for ease of storage and transport.

### BRIEF SUMMARY OF THE INVENTION

In brief, the present invention provides a recreational device having a large rotatable outer wheel or ring, a frame disposed internally within the wheel and about which the wheel is rotatable, a pivotable foot platform attached to the frame, and a tail wheel assembly disposed outbound and rearward of the large wheel and coupled to the platform. In use a rider stands on the platform, preferably in a sideways stance, and grasps hand grips on the frame members and steers the wheel by applying torque to the frame.

The tail wheel assembly is coupled to the foot platform by pulleys and cable such that pivoting of the platform causes pivoting of the tail wheel assembly to aid in steering the device. A hand brake can be provided to control the speed of rotation of the wheel about the frame. A nose wheel assembly can be provided having a nose wheel forward of the large wheel and which can engage the ground during braking to aid in stable operation. The tail assembly can be folded for ease of storage and transport.

### BRIEF DESCRIPTION OF THE SEVERAL VIEWS OF THE DRAWING

The invention will be more fully described in the following detailed description in conjunction with the drawings in which:

FIG. 1 is an elevation view of a preferred embodiment of the recreational device according to the invention;

FIGS. 2A-2C illustrate an optional handle bar assembly attachable to the frame;

FIGS. 3A and 3B illustrate the action of the hinged tail wheel;

FIGS. 4A and 4B illustrate the over center weighting of the original recreational device and the rear weighting of the offset steering platform of the present device;

FIG. 4C illustrates the forces that result in a turning moment on the steering platform;

FIGS. 5A-5C illustrate changes in the angle of the tail pivot which causes changes in the steering and handling characteristics of the outer wheel;

FIG. 6 shows the wire rope and pulley arrangement that couples the steering platform to the tail wheel assembly;

FIG. 7 shows a brake assembly;

FIG. 8 shows a safety nose wheel assembly;

FIGS. 9A and 9B show the hinged tail wheel assembly and foldup details;

FIG. 10 shows an alternative implementation providing increased ground clearance for the tail wheel assembly; and

FIG. 11 is a cross-sectional view of the outer wheel.

### DETAILED DESCRIPTION OF THE INVENTION

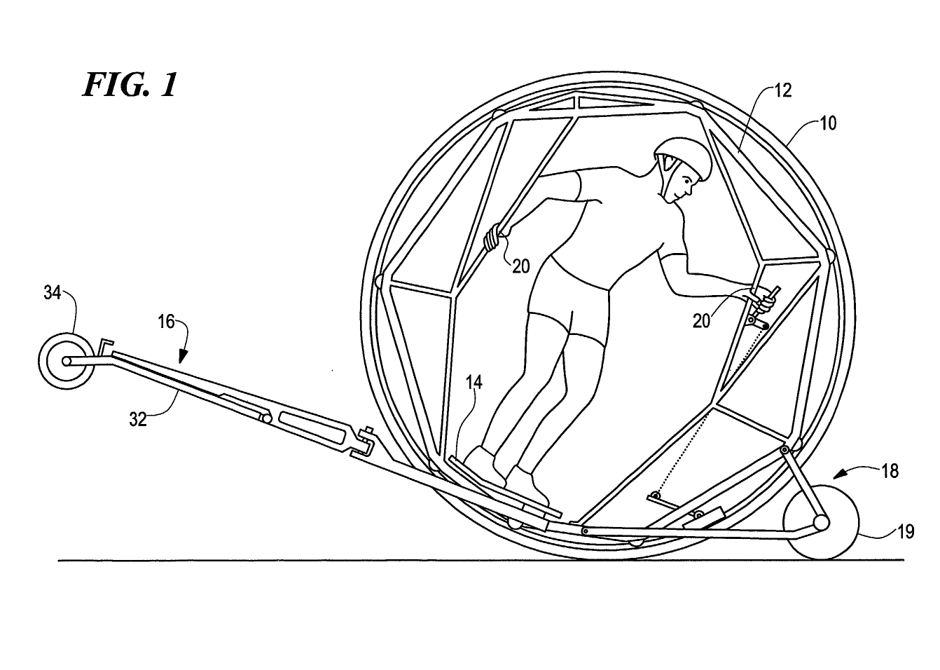

Referring to FIG. 1, there is shown a preferred embodiment of a recreational device in accordance with the invention, which comprises an outer wheel or ring 10 rotatable about a frame 12 having a foot platform 14 on which a rider can stand, a tail wheel assembly 16 and a nose wheel assembly 18. The wheel 10 is of a diameter sufficient to permit a rider to stand therein in a normal upright riding position.

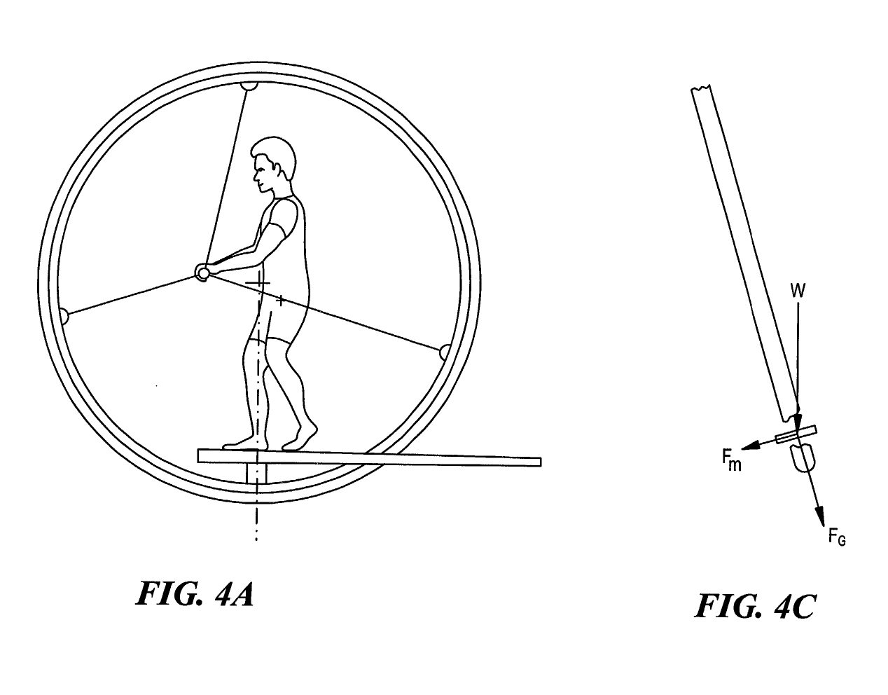

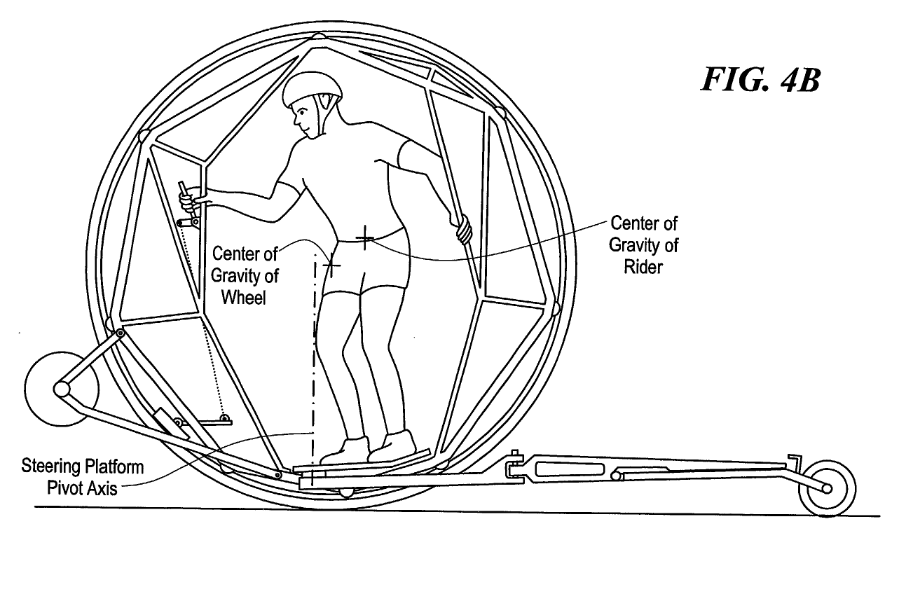

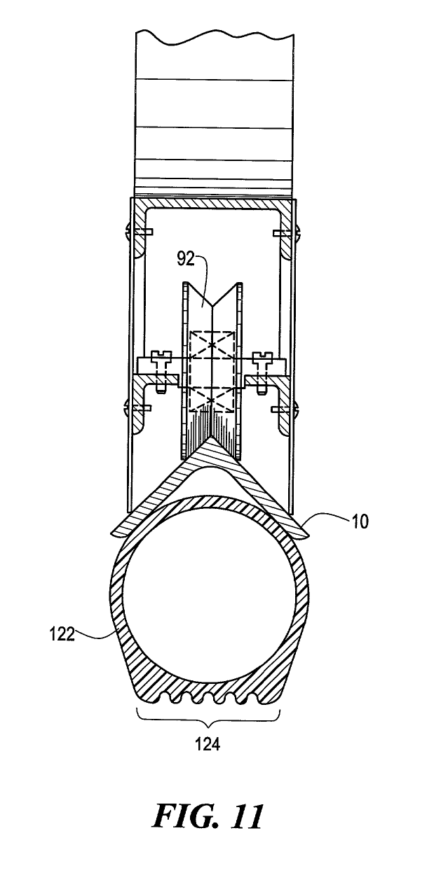

The outer wheel 10 in the present embodiment can be constructed as in the above-identified U.S. Pat. No. 4,302,006 and a cross-section view of which is shown in FIG. 11, which corresponds with FIG. 4 of the '006 patent. An annular member 120 has an inverted V-shaped cross-section with the apex of the V being accommodated within the V-shaped cross-section of a bearing wheel 92. A tire 122 or other tubular member is attached at the open end of the V-shaped member 120, having a tread 124 or other outer surface suitable for the terrain on which the device is to be utilized. A plurality of bearing wheels 92 are provided about the periphery of the frame.

The frame 12 is torsionally stiff and internally braced and is made from high strength round aluminum alloy tubing. The frame is lightweight, torsionally rigid, and the triangular bracing provides radial stiffness and strength. Hand holds or grips 20 are provided on portions of the frame such that the device can be ridden with a preferred side facing stance as illustrated in FIG. 1, as well as a forward facing position as shown in the above-identified patent.

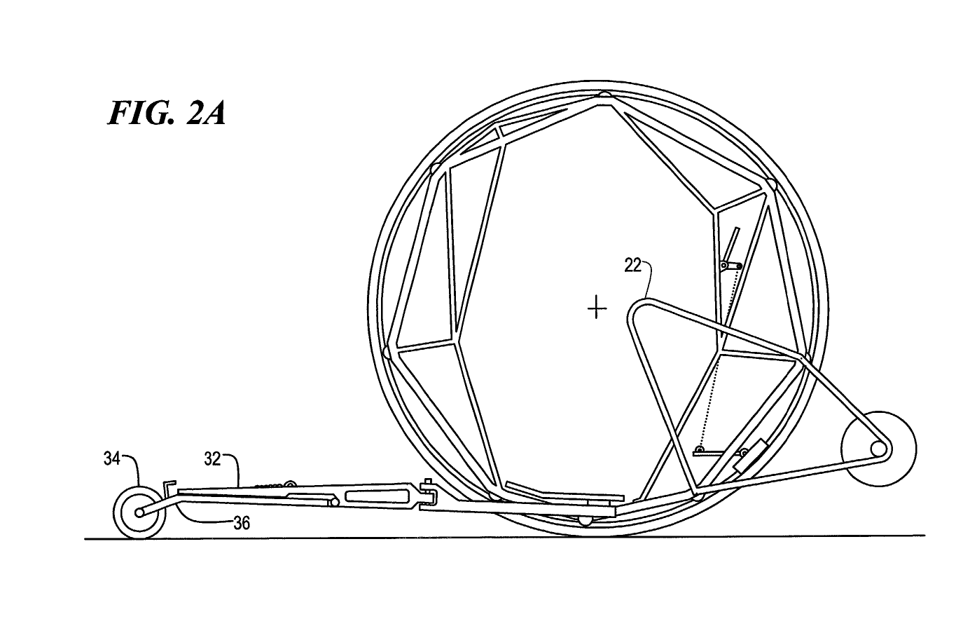

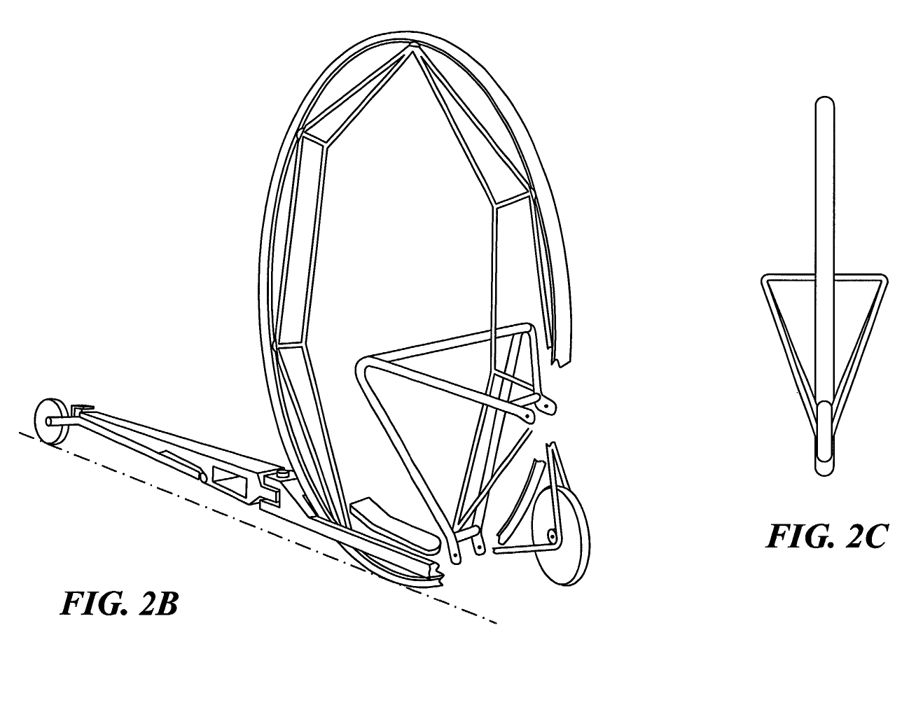

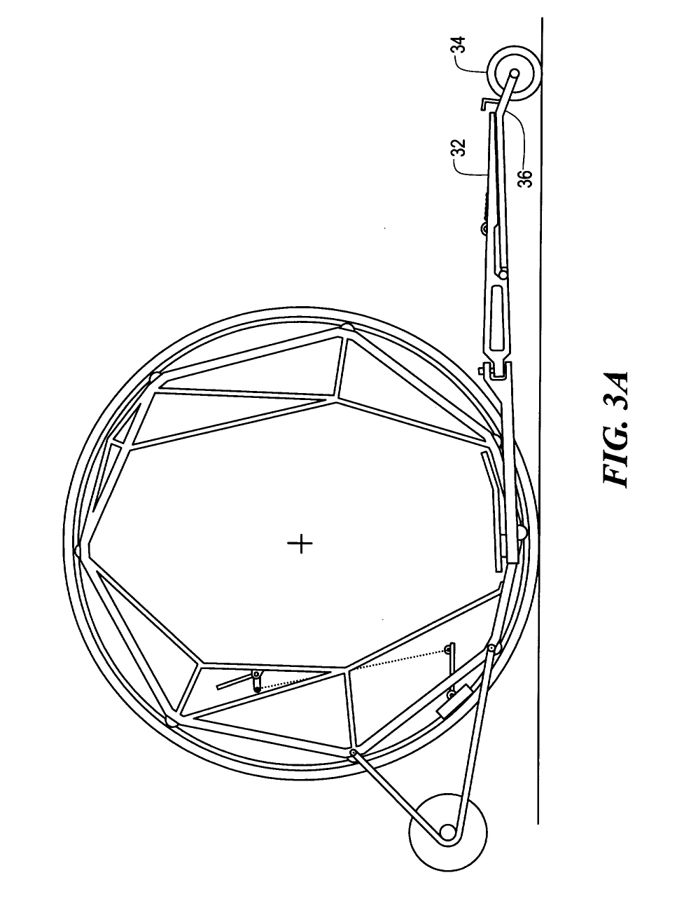

A handle bar assembly 22 can be attached to the frame 12 as illustrated in FIGS. 2A-2C for use by first-time or inexperienced riders. The handle bars provide a convenient way of maintaining a riding position and providing turning forces to the device. The interior of the frame 12, with or without the handlebars, is relatively open to permit positioning of the rider in a broad range of positions within the frame and on the foot platform. The rider can be positioned rearward of the center of gravity of the outer wheel and thus provide better stability and compensation for braking forces, as will be further described below. The handle bar assembly can be attached to the frame by a quick connect fastener for ease of attachment and detachment.

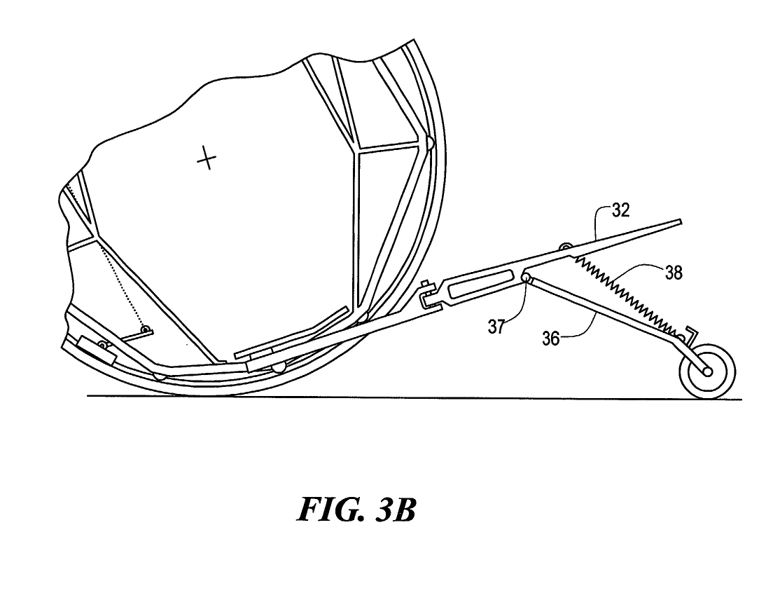

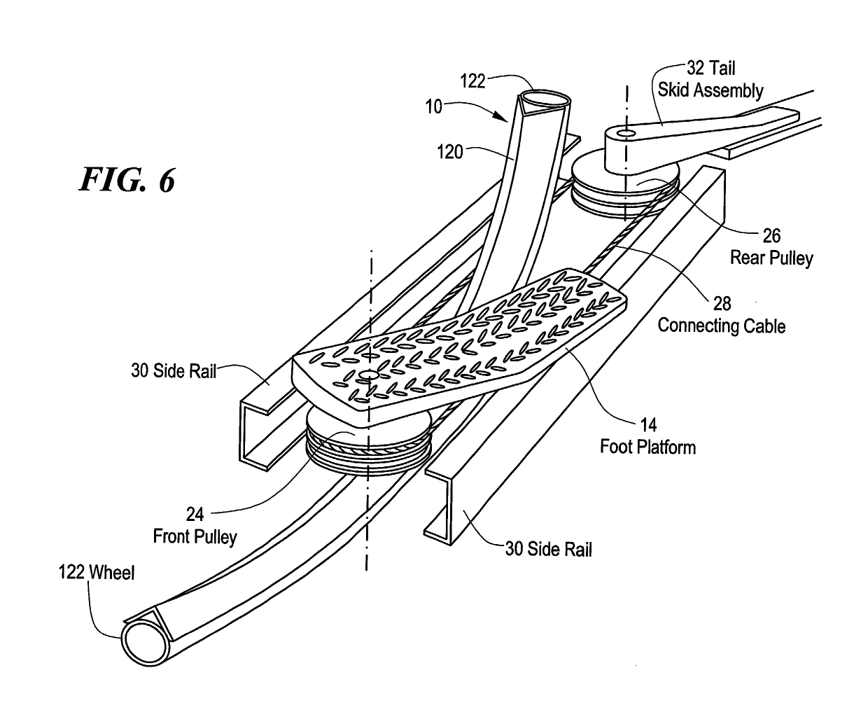

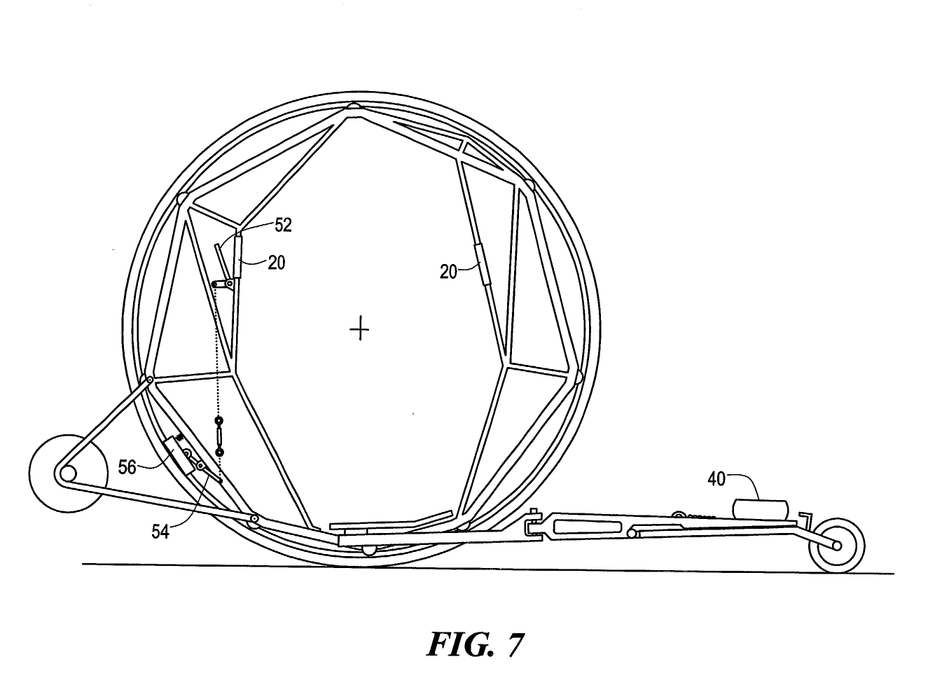

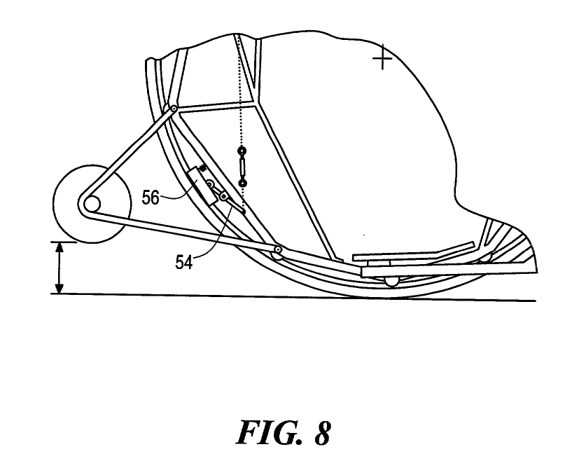

The foot platform 14 is coupled to a steering mechanism to which the tail wheel assembly 16 is coupled such that rotation of the foot platform by a rider causes corresponding rotation of the tail wheel assembly to aid in steering of the device. As seen in FIG. 6, the forward end of the foot platform 14 is connected to a front pulley 24 and is rotatable therewith about the axis of the pulley. The front pulley is coupled to a rear pulley 26 by a connecting steering cable 28. The pulleys are supported by a structure including side rails 30 connected to the frame. In the illustrated embodiment, the rear pulley 26 is outward of the outer wheel 10. The rear pulley 26 is connected to the member 32 of the tail wheel assembly 16, which is pivotable with the rear pulley about the pivot axis thereof. The member 32 has a tail wheel 34 connected at the outer end thereof and rotatable about the wheel axis. As shown in FIGS. 3A and 3B, the tail wheel 34 and the strut 36 to which it is attached is preferably hinged to the pivotable member 32 of the tail wheel assembly such that the tail wheel can remain in contact with the ground over rough or uneven terrain which can cause the main wheel to pitch forward and back. The hinge 37 is normally horizontal and permits movement of the strut 36 and wheel 36 in the plane of the outer wheel 10. The hinged strut 36 is connected to the member 32 by a spring 38 that provides a rearward restoring force to the main wheel when it pitches forward. When the main wheel 10 is as far forward as it can go, there is still enough weight in the tail wheel 34 and its supporting strut to keep the tail wheel in contact with the ground. If needed, an additional weight 46 can be added to the tail wheel assembly as shown in FIG. 7. If the tail wheel lifts off of the ground during propulsion of the main wheel, steering control can be impaired. Thus, the maintenance of the tail wheel in contact with the ground achieves reliable and continuous steering control.

Referring to FIG. 4A and 4B, there is shown a comparison of the foot steering platform position in the original '006 patent and in the present invention. The pivot of the foot steering platform has been moved forward in the present invention as shown in FIG. 4B. As the main wheel leans into a turn this offset position transfers a component of the operator's weight into a turning moment acting on the steering platform in the direction of the turn. This turning moment adds to the moment applied by the operator thereby requiring less effort by the operator to complete a turn. The forces are illustrated in FIG. 4C. The vector Fₘ of the operator's weight W produces a lateral force that results in a turning moment on the steering platform.

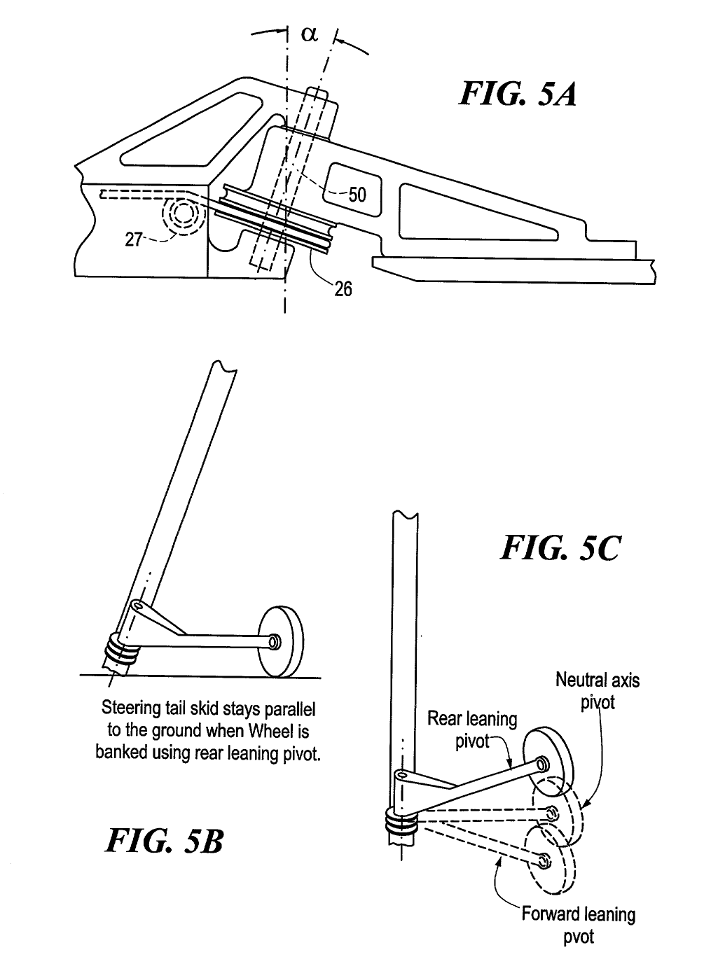

As seen in FIGS. 5A-5C, the pivot axis 50 of the tail assembly is rearwardly inclined by an angle α which produces a steering moment on the tail assembly in a turn when the operator shifts his weight rearward. Coming out of the turn, the operator shifts his weight forward and thus removes both turning moments to the platform. The pulleys and wire rope which couple the steering platform to the tail wheel assembly provide a smooth turning action and a very slim width profile to the device. It is preferable to have a device with a slim width especially when the device is banked against a slope where any lateral protuberance could catch on the ground and upset the device and rider. In this embodiment, the angular orientation of the rear pulley 26 is accommodated by pulleys 27 which are cooperative with the steering cable 28.

The hand grips 20 are illustrated more particularly in FIG. 7 which also shows a brake handle 52 coupled to a brake mechanism 54 having a brake shoe 56 which is urged into engagement with the main wheel 10 by actuation of the brake handle to slow and stop rotation of the main wheel. The hand operated brake provides speed control and stopping of the wheel. The nose wheel assembly 18 prevents overturning of the frame 12 when the brake is applied. The nose wheel 19 normally rides off of the ground by typically one foot, and only makes contact with the ground during hand braking when the operator back weighting is not enough to compensate for the braking force.

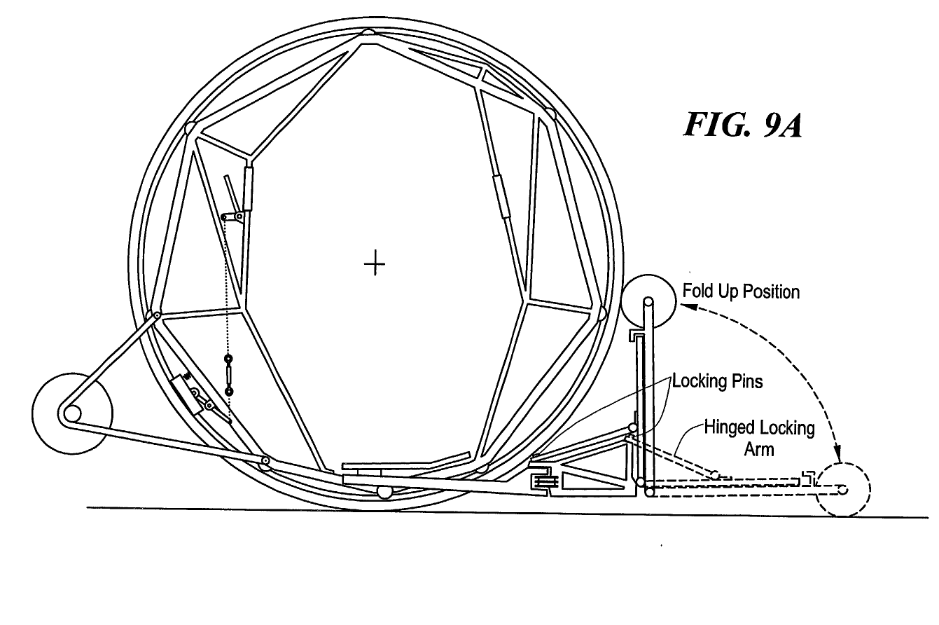

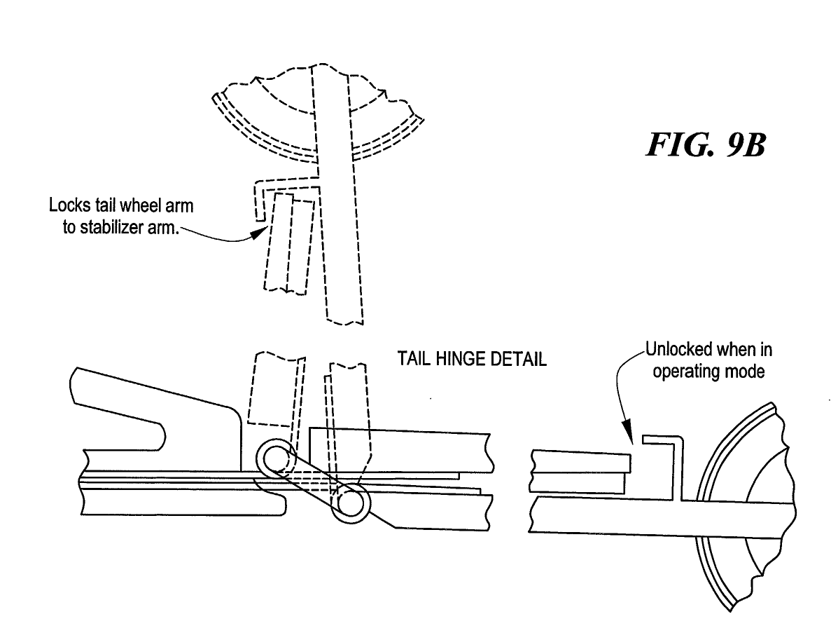

For the convenience of transporting and storing the device, the tail assembly can be folded up as shown in FIGS. 9A and 9B. In the folded position a lock mechanism (not shown) can be employed to retain the tail assembly in its raised or folded position.

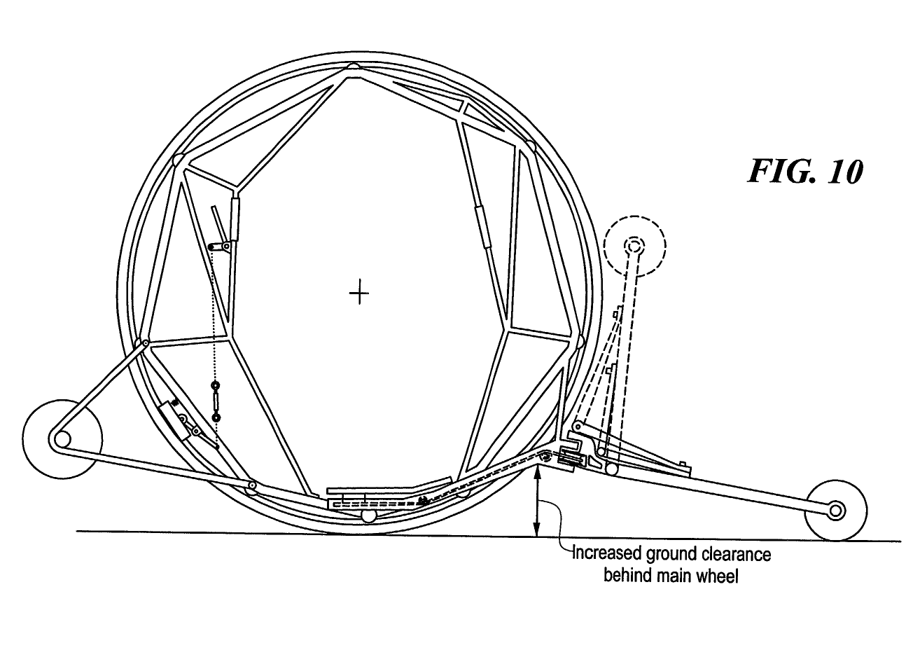

An alternative embodiment is shown in FIG. 10 which provides greater ground clearance which is especially useful when traversing rough ground. The greater ground clearance behind the main wheel reduces forward and backward pitching of the main wheel when running over uneven terrain. Whenever the main wheel drops into a depression or large hole in the ground, the tail can be whipped upward with considerable force causing the forward pitching movement of the entire device. The greater clearance behind the main wheel significantly reduces this effect.

The invention is not limited by what has been particularly shown and described but is intended to embrace the spirit and full scope of the claims.

What is claimed is:

1. A recreational device comprising:
an outer wheel;
a frame mounted within the outer wheel and about which the wheel is rotatable;
a platform coupled to the frame and adapted to support a rider within the frame, the platform being pivotably mounted to a portion of the frame;
a tail wheel assembly extending aft of the outer wheel and having a tail wheel adapted to rest on the ground, the assembly coupled to the platform such that the tail assembly moves in the same direction as the aft portion of the platform; and
hand grips on portions of the frame and adapted to be grasped by the rider for enabling the rider to apply a torque to the frame.

2. The recreational device of claim 1 wherein the frame is of lightweight torsionally rigid construction having an open central area of a size sufficient to accommodate a rider standing on the platform.

3. The recreational device of claim 2 wherein the frame is of high strength aluminum tubing.

4. The recreational device of claim 1 further including a handle bar assembly attached to the frame and having portions for hand gripping by a rider.

5. The recreational device of claim 4 wherein the handle bar assembly can be attached and detached from the frame.

6. The recreational device of claim 1 wherein the tail wheel assembly includes a member pivotably attached to the frame.

7. The recreational device of claim 6 wherein the tail wheel assembly includes a strut having the tail wheel attached at the outer end thereof, the inner end being pivotably attached to a member, the pivot axis of the strut being orthogonal to the plane of the outer wheel;
the member being pivotably attached to the frame about an axis which is generally in the plane of the outer wheel.

8. The recreational device of claim 7 including a spring between the strut and the member and operative to provide a restoring force to the outer wheel when it pitches forward.

9. The recreational device of claim 1 wherein the platform is pivotably mounted to a portion of the frame by a steering mechanism; and
wherein the tail wheel assembly is coupled to the steering mechanism such that rotation of the platform by a rider causes corresponding rotation of the tail wheel assembly to aid in steering of the device.

10. The recreational device of claim 9 wherein the steering mechanism includes a front pulley connected to the forward end of the foot platform and rotatable therewith;
a rear pulley connected to the tail wheel assembly and rotatable therewith; and
a cable coupling the front pulley and rear pulley and operative to provide rotation of the rear pulley upon rotation of the front pulley.

11. The recreational device of claim 1 including a nose wheel assembly extending forward of the outer wheel and having a nose wheel operative to engage the ground during braking of the outer wheel, the nose wheel assembly coupled to the frame.

12. The recreational device of claim 1 wherein the tail wheel assembly is hinged to provide folding of the assembly upward from the ground for ease of storage and transport.

13. The recreational device of claim 1 including a brake mechanism including one or more brake handles operable by a user and coupled to one or more brake shoes cooperative with the outer wheel to provide a braking force thereto.

14. The recreational device of claim 1 wherein the tail wheel assembly includes a wheel support connecting the tail wheel to the platform, the support being angled upward from the ground to provide greater ground clearance.

15. The recreational device of claim 7 wherein the pivot access of the member is rearwardly inclined by a predetermined angle.

16. The recreational device of claim 7 wherein the pivot access of the member is normally vertical.
